(19) United States
(12) Patent Application Publication
(10) Pub. No.: US 2026/0349003 A1
(43) Pub. Date: Nov. 5, 2026

(54) INERTIAL SENSOR SYSTEM FOR A VEHICLE AND METHOD FOR OPERATING SAME

(71) Applicant: Robert Bosch GmbH, Stuttgart (DE)

(72) Inventors: Simon Schrade, Baindt (DE); Xi Nowak, Bisingen (DE)

(21) Appl. No.: 19/549,322

(22) Filed: Feb. 25, 2026

(30) Foreign Application Priority Data
Mar. 13, 2025 (DE) 10 2025 109 617.1

(51) Int. Cl. G01P 15/18; B60R 21/01; B60R 21/0132

(52) U.S. Cl. CPC G01P 15/18; B60R 21/0132; B60R 2021/01259; B60R 2021/01327

(57) ABSTRACT

An inertial sensor system for a vehicle. The inertial sensor system has an acceleration sensor in at least two three-dimensionally spaced locations of the vehicle, each acceleration sensor measuring in at least two axes, wherein the acceleration sensors each map a direction of action of a local centripetal acceleration in an acceleration vector, wherein the inertial sensor system is configured to determine an instantaneous center of rotation of the vehicle using the at least two acceleration vectors.

### FIELD

The present disclosure relates to an inertial sensor system for a vehicle, to a method for operating a corresponding inertial sensor system, and to a corresponding computer program product.

### BACKGROUND INFORMATION

A vehicle can have a yaw rate sensor. The yaw rate sensor is conventionally located centrally in a control unit. In order for the measurements of the yaw rate sensor to be meaningful, it is advantageous if the control unit is located as close as possible to the center of gravity of the vehicle.

### SUMMARY

The approach presented here presents an inertial sensor system for a vehicle, a method for operating a corresponding inertial sensor system, and a corresponding computer program product. Advantageous developments and improvements of the approach presented here emerge from the disclosure herein.

According to an example embodiment, an inertial sensor system for a vehicle is provided, wherein the inertial sensor system has an acceleration sensor in at least two three-dimensionally spaced locations of the vehicle, each acceleration sensor measuring in at least two axes, wherein the acceleration sensors each map a direction of action of a local centripetal acceleration in an acceleration vector, wherein the inertial sensor system is configured to determine an instantaneous center of rotation of the vehicle using the at least two acceleration vectors.

In the approach presented here, at least two decentralized acceleration sensors are distributed in the vehicle, as an alternative or in addition to a centrally located yaw rate sensor. The acceleration sensors have a known distance from one another. The acceleration sensors are located in particular on wheels of the vehicle. The acceleration sensors detect local accelerations in at least two spatial directions. The local accelerations also comprise local centrifugal and centripetal accelerations. Through multidimensional detection, the acceleration sensors detect a local direction of action of the local accelerations. The directions of action measurable by the different acceleration sensors differ due to the distributed arrangement. An instantaneous center of rotation of the vehicle is located at an intersection of the directions of action.

The approach presented here eliminates the need for a centrally located yaw rate sensor. As a result, costs for this central yaw rate sensor can be saved. Alternatively, the decentralized acceleration sensors can provide redundancy to the central yaw rate sensor and increase the fail-safety and robustness of the overall system.

In particular, local control units of electromechanical brakes contain acceleration sensors anyway, which can additionally perform the function proposed here through the use proposed here.

According to a first aspect of the present disclosure, an inertial sensor system for a vehicle is proposed, wherein the inertial sensor system has an acceleration sensor in at least two three-dimensionally spaced locations of the vehicle, each acceleration sensor measuring in at least two axes, wherein the acceleration sensors each map a direction of action of a local centripetal acceleration in an acceleration vector, wherein the inertial sensor system is configured to determine an instantaneous center of rotation of the vehicle using the at least two acceleration vectors.

According to a second aspect of the present disclosure, a method for operating an inertial sensor system of a vehicle is provided, wherein, in at least two three-dimensionally spaced locations of the vehicle, a direction of action of a local centripetal acceleration is detected in at least two axes and each mapped in an acceleration vector, wherein the at least two acceleration vectors are evaluated in order to determine an instantaneous center of rotation of the vehicle.

Ideas for embodiments of the present disclosure may be considered, inter alia, as being based on the concepts and findings described below.

An inertial sensor system can in particular detect accelerations using acceleration sensors. The accelerations can be resolved in at least two spatial directions. The spatial directions run transversely, in particular perpendicularly to one another. The acceleration sensors can reproduce detected accelerations in electrical signals. The signals can be sent via data lines to a central data processing device. The accelerations can be output as a multidimensional acceleration vector.

By resolving the accelerations in at least two spatial directions, the directions of action of the accelerations can be determined. An instantaneous center of rotation of the vehicle is situated at the point where the directions of action intersect, starting from a location of detection. At the time of detection, the instantaneous center of rotation is the pivot point about which the vehicle moves.

The acceleration sensors can be spaced from one another. A distance between adjacent acceleration sensors can be greater than the typical dimensions of a control unit in a vehicle. For example, this distance can be greater than 30 cm, greater than 50 cm, greater than 1 m or even greater than 1.5 m.

The acceleration sensors can be located in the region of wheels of the vehicle. The wheels of the vehicle are far away from one another and from a center point of the vehicle. In this case, the distance between adjacent acceleration sensors can correspond to the distance between adjacent wheels of the vehicle. This results in a large difference between the directions of action and thus a precise determination of the instantaneous center of rotation.

The acceleration sensors can be located in local control units of electromechanical brakes of the vehicle. Such local control units are typically located near or inside the wheels of a vehicle. An acceleration sensor can be installed anyway in local control units of electromechanical brakes. In addition to closed-loop and open-loop control of the brake, the acceleration sensor can also be used to determine the instantaneous center of rotation.

The inertial sensor system can have acceleration sensors in the region of all wheels of the vehicle. Accordingly, the number of acceleration sensors of the inertial sensor system can correspond to the number of wheels on the vehicle. The accuracy of the determination of the instantaneous center of rotation can be increased by increasing the number of measurement points. Additionally, measurement errors in the detection of centripetal acceleration can be filtered out, and the inertial sensor system can be made more robust.

The directions of action of the centripetal accelerations can be detected at least in a horizontal plane. The instantaneous center of rotation can be determined at least in the horizontal plane. A horizontal plane can be oriented substantially parallel to the ground beneath the vehicle. During normal driving, it is particularly advantageous to determine the instantaneous center of rotation in the horizontal plane.

The directions of action of the local centripetal accelerations can also be detected in three axes. Then the instantaneous center of rotation can be determined three-dimensionally. By determining the instantaneous center of rotation three-dimensionally, pitch movements of the vehicle and/or roll movements of the vehicle about the instantaneous center of rotation can be detected.

Furthermore, a yaw rate of the vehicle can be determined using the acceleration vectors. The yaw rate is the movement about the instantaneous center of rotation. The yaw rate can be derived from the magnitude of the local accelerations. The greater the accelerations, the greater the yaw rate generally is.

A longitudinal force distribution of the vehicle can be influenced using the instantaneous center of rotation. Taking into account the instantaneous center of rotation, wheels or axles of the vehicle can be individually accelerated or braked to stabilize the vehicle.

Furthermore, rotation speed sensors of the wheels can be read to determine the instantaneous center of rotation. The determination of the instantaneous center of rotation can be verified by rotation speed information from the rotation speed sensors. Unrealistic locations of the instantaneous center of rotation can thus be easily excluded.

The method is preferably computer-implemented and can be implemented, for example, in software or hardware or in a mixed form of software and hardware, for example in a control unit.

A computer program product or a computer program which has program code that can be stored on a machine-readable carrier or storage medium, such as a semiconductor memory, a hard disk memory, or an optical memory, and that is used for carrying out, implementing, and/or controlling the steps of the method according to one of the embodiments described above, in particular when the program product or program is executed on a computer or an apparatus, is advantageous as well.

It is pointed out that some of the possible features and advantages of the present disclosure are described herein with reference to different embodiments. A person skilled in the art recognizes that the features of the control unit and of the method can be suitably combined, adapted or replaced in order to arrive at further embodiments of the present disclosure.

### BRIEF DESCRIPTION OF THE DRAWINGS

Embodiments of the present disclosure are described below with reference to the figures, and neither the figures nor the description should be construed as limiting the present disclosure.

FIGS. 1 and 2 show representations of vehicles with inertial sensor systems according to exemplary embodiments.

The figures are merely schematic and not true to scale. Identical reference signs denote identical or identically acting features.

### DETAILED DESCRIPTION OF EXAMPLE EMBODIMENTS

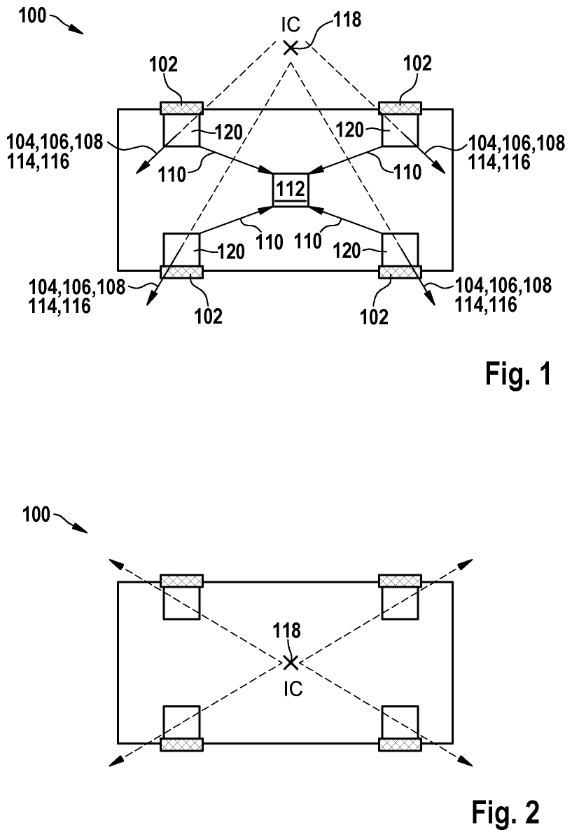

FIG. 1 shows a representation of a vehicle having an inertial sensor system 100 according to an exemplary embodiment. The inertial sensor system 100 has an acceleration sensor 104 in the region of at least two wheels 102 of the vehicle. The acceleration sensors 104 can resolve locally occurring accelerations 106 in at least two spatial directions. Here, the resolved spatial directions lie in a horizontal plane. The acceleration sensors 104 can therefore—with reference to a vehicle coordinate system—detect accelerations 106 in the X direction and Y direction and reproduce a resulting acceleration vector 108 in an acceleration signal 110.

The acceleration signals 110 are read and evaluated by a central control unit 112 of the inertial sensor system 100.

Because the acceleration sensors 104 are located in the region of different wheels 102 of the vehicle, the acceleration sensors 104 are spaced from one another by a structurally predefined distance. When the vehicle moves along a curved trajectory, centrifugal forces act on the acceleration sensors 104, and the acceleration sensors 104 each detect a local centripetal acceleration 114 and reproduce a direction of action 116 of the centripetal acceleration 114 as a component of the acceleration vector 108 in the acceleration signal 110.

The directions of action 116 of the local centripetal accelerations 114 intersect at a current instantaneous center of rotation 118 of the vehicle. The directions of action 116 differ significantly due to the distance between the acceleration sensors 104. A position of the instantaneous center of rotation 118 is determined in the central control unit 112 by triangulation of the directions of action 116 over the distance.

In this case, the instantaneous center of rotation 118 is to the side of the vehicle. The vehicle is therefore cornering.

In one exemplary embodiment, the acceleration sensors 104 are integrated into local control units 120 of electromechanical brakes of the vehicle. The acceleration signals 110 can be used, for example, in the local control units 120 to monitor and/or actuate the brakes.

In one exemplary embodiment, acceleration sensors 104 are located on all wheels 102 of the vehicle.

In one exemplary embodiment, the acceleration sensors 104 are three-axis acceleration sensors, meaning they can detect the accelerations 106 in all spatial directions. As a result, the acceleration vectors 108 are likewise three-dimensional, and the instantaneous center of rotation 118 can be determined three-dimensionally in the central control unit 112. As a result, not only yaw movements about the vertical axis of the vehicle, but also pitch movements about the transverse axis and roll movements about the longitudinal axis of the vehicle can be detected.

FIG. 2 shows a representation of a vehicle having an inertial sensor system 100 according to an exemplary embodiment. The inertial sensor system 100 substantially corresponds to the inertial sensor system in FIG. 1. In contrast, the instantaneous center of rotation 118 in this case is located substantially in the center of the vehicle. The vehicle is therefore currently skidding about the vertical axis.

Possible embodiments of the present disclosure are summarized again below or described using slightly different words.

The use of acceleration sensors of electromechanical brakes to measure the yaw rate of a vehicle is presented.

Conventionally, hydraulic braking systems are used. The driver then has mechanical access to the brake. It is possible that electromechanical brakes (EMBs) will be used more and more in the future and will be able to displace hydraulic braking systems. In this case, power is supplied to an electric motor, the resulting torque is converted by a transmission into a translation, and a caliper with pads generates a deceleration of the vehicle through friction.

Furthermore, an EMB actuator can be equipped with sensors, such as a current sensor, an EMB position sensor and/or a wheel speed sensor. This can be referred to as a ‘smart actuator’. In particular, acceleration sensors (e.g. MEMS) can be used cost-effectively within the ECU to measure accelerations (x, y and/or z direction), vibrations, or sound.

The EMB actuator can be attached to any of the wheels of a vehicle, creating a system. One possible architecture/topology can consist of a central control unit, a communication bus and the EMB actuators.

In a conventional H-circuit topology for braking systems, the central control units handle the brake force distribution and command the EMB actuators.

The approach presented here allows the angular velocity of a vehicle to be reliably measured. This measurement can be fed into the ESP, allowing the ESP to detect the driving situation better.

For this purpose, the acceleration sensors in the control unit of the EMB are used to measure the angular velocity of the vehicle. This is achieved using the distributed nature of the acceleration sensors, which triggers different centripetal forces. The yaw rate can be reliably determined thereby.

The advantage lies in the robustness of the measurement, since multiple sensors are used.

With the traditional yaw rate sensor, it is necessary in particular to install it as close as possible to the center of gravity of the vehicle to ensure good measurement accuracy. If the yaw rate sensor is not installed at the center of gravity of the vehicle, complex coordinate transformations are necessary.

The approach presented here is based on the measurement of the centripetal acceleration (a_centri) that occurs when there is a rotational movement with the radius r and the speed v, or a yaw rate. The following equations describe the basic physical principle:

$${F}_{Z} = \frac{m {v}^{2}}{r} = m {a}_{c entri}$$

$${a}_{centri} = \frac{{v}^{2}}{r}$$

Here, the radius r describes the distance from the instantaneous center of rotation (IC). An initial problem is that the acceleration sensors can only measure a_centri, but both the rotational speed v and the radius r are unknown. This problem is solved by the distributed nature of the EMB actuators, by taking at least two measurements on two EMBs of the vehicle. FIGS. 1 and 2 show two examples with four acceleration sensors. These figures show the determination of the instantaneous center of rotation using a_centri when the vehicle is cornering and skidding, respectively.

The arrows mark the measured centripetal accelerations a_centri. The intersection point of the a_centri vectors gives the instantaneous center of rotation (IC) about which the vehicle rotates.

In a minimal variant, at least two acceleration sensors in the x and y directions (in a plane parallel to the road) are required, installed in two different actuators. However, it is more advantageous to install four sensors that measure in at least two different directions, of which none of the sensors measuring in the same direction are installed in the same EMB as another sensor measuring in the same direction. These sensors can be installed in two, three, or four EMBs. For simplicity, it is assumed in this case that there are two acceleration sensors that measure in the x and y directions and are installed in two EMBS.

In one exemplary embodiment, however, three or four acceleration sensors are also installed in different EMBs to improve the robustness of the measurement (cf. GPS with three or four satellites).

In one exemplary embodiment, acceleration sensors that measure in three axes are used instead of acceleration sensors that measure in two axes. This allows a three-dimensional instantaneous center of rotation to be determined, which in turn allows the IC of both roll and pitch movements to be determined.

In one exemplary embodiment, an actuation force distribution for braking, drive, steering and suspension is derived from the yaw, roll and/or pitch movement (if measured).

In particular, the measured force distribution can be compared with the desired force distribution, which allows the vehicle actuators (at least EMB, but steering, drive and suspension are also possible) to be monitored, or a control loop to be closed.

In one exemplary embodiment, monitoring is also carried out between acceleration, yaw rate (if present) and wheel speed sensors.

In one exemplary embodiment, vehicle stability systems access the collected/processed data.

Finally, it should be pointed out that terms like “having,” “comprising,” etc. do not exclude other elements or steps and terms like “a” or “an” do not exclude a plurality.

1-12. (canceled)

13. An inertial sensor system for a vehicle, comprising:
a respective acceleration sensor in each of at least two three-dimensionally spaced locations of the vehicle, each respective acceleration sensor measuring in at least two axes, wherein the respective acceleration sensors each map a direction of action of a local centripetal acceleration in a respective acceleration vector;
wherein the inertial sensor system is configured to determine an instantaneous center of rotation of the vehicle using the respective acceleration vectors.

14. The inertial sensor system according to claim 13, wherein the respective acceleration sensors are located in a region of wheels of the vehicle.

15. The inertial sensor system according to claim 14, wherein the respective acceleration sensors are located in local control units of electromechanical brakes of the vehicle.

16. The inertial sensor system according to claim 14, wherein the inertial sensor system has the respective acceleration sensors in the region of all wheels of the vehicle.

17. A method for operating an inertial sensor system of a vehicle, the method comprising the following steps:
detecting, in at least two three-dimensionally spaced locations of the vehicle, a direction of action of a local centripetal acceleration in at least two axes, and each of the directions of action being mapped in a respective acceleration vector; and
evaluating the respective acceleration vectors to determine an instantaneous center of rotation of the vehicle.

18. The method according to claim 17, in which the directions of action of the local centripetal accelerations are detected at least in a horizontal plane, wherein the instantaneous center of rotation is determined at least in the horizontal plane.

19. The method according to claim 17, wherein the directions of action of the local centripetal accelerations are detected in three axes, and wherein the instantaneous center of rotation is determined three-dimensionally.

20. The method according to claim 17, wherein a yaw rate of the vehicle is also determined using the respective acceleration vectors.

21. The method according to claim 17, wherein a longitudinal force distribution of the vehicle is influenced using the instantaneous center of rotation.

22. The method according to claim 17, wherein rotation speed sensors of wheels of the vehicle are also read in order to determine the instantaneous center of rotation.

23. A non-transitory machine-readable storage medium on which is stored a computer program for operating an inertial sensor system of a vehicle, the computer program, when executed by a processor, causing the processor to perform the following steps comprising:
detecting, in at least two three-dimensionally spaced locations of the vehicle, a direction of action of a local centripetal acceleration in at least two axes, and each of the directions of action being mapped in a respective acceleration vector; and
evaluating the respective acceleration vectors to determine an instantaneous center of rotation of the vehicle.
